(19) United States
(12) Patent Application Publication
(10) Pub. No.: US 2015/0333884 A1
(43) Pub. Date: Nov. 19, 2015

(54) Beam Forming Using a Two-Dimensional Antenna Arrangement

(71) Applicant: Telefonaktiebolaget L M Ericsson (publ), Stockholm (SE)

(72) Inventor: Fredrik ATHLEY, Kullavik (SE)

(73) Assignee: Telefonaktiebolaget L M Ericsson (publ), Stockholm (SE)

(21) Appl. No.: 14/358,112

(22) PCT Filed: May 8, 2014
(86) PCT No.: PCT/EP2014/059437

§ 371 Date: May 14, 2014

(51) Int. Cl. H04L 5/00; H04B 7/04

(52) U.S. Cl. CPC H04L 5/0048; H04B 7/0456

(57) ABSTRACT

There is provided two-dimensional beam forming using a two dimensional antenna array. The beam forming comprises alternatingly transmitting a first set of reference signals for channel state information using a two-dimensional antenna array as a first essentially linear array and as a second essentially linear array substantially perpendicular to the first linear array, respectively. When used as the first linear array one reference signal of the first set per virtual antenna port in said first linear array is transmitted. When used as the second linear array one reference signal of the first set per virtual antenna port in the second linear array is transmitted.

### TECHNICAL FIELD

Embodiments presented herein relate to two-dimensional beam forming, and particularly a method, a two-dimensional antenna array, and a computer program for two-dimensional beam forming.

### BACKGROUND

In communications networks, it may be challenging to obtain good performance and capacity for a given communications protocol, its parameters and the physical environment in which the communications network is deployed.

One component of wireless communications networks where it may be challenging to obtain good performance and capacity is the antennas of network nodes configured for wireless communications; either to/from another network node, and/or to/from a wireless user terminal.

For example, multi-antenna transmission techniques are used in several wireless communication standards, e.g. the Long Term Evolution (LTE) telecommunications standard of the 3rd Generation Partnership Project (3GPP), in order to increase system capacity and coverage. A particular transmission mode is codebook-based precoding in which the radio base station (such as an evolved Node B, or eNB) of the network transmits one or several beam formed data streams to the wireless end-user terminals (denoted user equipment, or UE). The beam forming weights are selected from a standardized codebook based on recommendations transmitted from the UE. In order for the UE to be able to recommend beam forming weights the radio base station first transmits pre-determined reference signals which are used by the UE to estimate the complex channel matrix between the radio base station and UE. This estimate may then be used to determine which weights in the codebook that for the UE will result in the best performance for the current channel state. Since there is only a finite number of eligible beam forming weights (as dictated by the codebook), only an index needs to be transmitted back from the UE to the radio base station. This index is referred to as a precoding matrix indicator (PMI). The radio base station may then select to transmit user data with the precoding matrix recommended by the UE, or with some other precoding matrix. For example, in transmission mode 4 (TM4) the radio base station may use another precoding matrix in the codebook, while in transmission mode 9 (TM9) there is no restriction on what precoding matrix for the radio base station to use. In the latter case, the codebook is only used to feedback quantized channel state information (CSI) whilst the demodulation of user data relies on precoded user-specific reference signals. For this reason, TM9 is sometimes referred to as non-codebook-based precoding.

In LTE several codebooks have been specified in the different standard releases. In principle, these codebooks may be used with any antenna configuration that has a matching number of antenna ports. However, since the codebooks have been designed for the most commonly deployed antenna configurations they may be more or less suitable for other types of antenna configurations. A typical antenna configuration suitable for the LIE release to codebook is an antenna having four columns of dual-polarized radiating elements with one antenna port for each column and polarization. Each antenna port is typically connected to a number of vertically stacked radiating elements via a feed network Together with the release 10 codebook such an antenna configuration may perform azimuth beam forming and polarization matching/multiplexing based on channel state reports from the UEs. No elevation beam forming can be performed with such an antenna configuration since there is only one antenna port per column available to baseband processing.

Although nothing in the standard prevents applying the existing codebook to a planar array, the LTE release to codebook may not be well suited for a planar array if applied in straightforward manner. A potentially desired property of rank-two precoding is that the beams for the different layers should have the same power pattern and orthogonal polarizations. However, this property may not be achieved when applying the LTE release to codebook directly on the antenna ports of a 2-by-2 dual-polarized rectangular array.

Hence, there is a need for improved beam forming.

### SUMMARY

An object of embodiments herein is to provide efficient beam forming.

According to a first aspect there is presented a method for two-dimensional beam forming using a two dimensional antenna array. The method comprises alternatingly transmitting a first set of reference signals for acquiring channel to state information using a two-dimensional antenna array as a first essentially linear array and as a second essentially linear array substantially perpendicular to the first linear array, respectively. When used as the first linear array one reference signal of the first set per virtual antenna port in the first linear array is transmitted. When used as the second linear array one reference signal of the first set per virtual antenna port in the second linear array is transmitted.

Advantageously this provides efficient beam forming.

Advantageously this enables existing LTE codebooks to be used with a planar antenna array, resulting in true 2-D beam forming.

Advantageously this enables 2-D precoding using a 1-D codebook.

Advantageously this enables existing LTE codebooks to be used to perform 2-D beam forming with an array with, for example, four times as many antenna ports compared to known antenna arrays, leading to higher gain and improved angular resolution compared to such known antenna arrays.

Advantageously this only requires a small overhead, or no overhead at all, when acquiring channel state information in both azimuth and elevation directions.

According to an embodiment the method further comprises alternatingly transmitting also a second set of reference signals for channel state information using the two-dimensional antenna array as said first essentially linear array and as the second essentially linear array, respectively. When transmitting one reference signal of the first set of reference signals using the first linear array, one reference signal of the second set of reference signals is simultaneously transmitted using the second linear array. When transmitting one reference signal of said first set of reference signals using the second linear array one reference signal of the second set of reference signals using the first linear array is simultaneously transmitted.

Advantageously this enables a large number of antenna ports to be simultaneously used for transmitting reference signals.

Advantageously this enables denser sampling in the acquisition of possible response signals to the thus transmitted reference signals, improving accuracy in channel estimation and thereby enabling higher beam forming gain, for example in subsequent data transmission.

According to a second aspect there is provided a two dimensional antenna arrangement for two-dimensional beam forming. The two dimensional antenna arrangement comprises a processing unit. The processing unit is configured to cause a two-dimensional antenna array to alternatingly transmit a first set of reference signals for acquiring channel state information using the two-dimensional antenna array as a first essentially linear array and as a second essentially linear array substantially perpendicular to the first linear array, respectively. The processing unit is configured such that it causes the two-dimensional antenna array to, when used as the first linear array, transmit one reference signal of the first set per virtual antenna port in the first linear array. The processing unit is configured such that it causes the two-dimensional antenna array to, when used as the second linear array, transmit one reference signal of the first set per virtual antenna port in the second linear array.

According to a third aspect there is presented a network node comprising a two dimensional antenna arrangement according to the second aspect.

According to a fourth aspect there is presented a wireless terminal comprising a two dimensional antenna arrangement according to the second aspect.

According to a fifth aspect there is presented a computer program for two-dimensional beam forming using a two dimensional antenna array, the computer program comprising computer program code which, when run on a processing unit, causes the processing unit to perform a method according to the first aspect.

According to a sixth aspect there is presented a computer program product comprising a computer program according to the fifth aspect and a computer readable means on which the computer program is stored.

It is to be noted that any feature of the first, second, third, fourth, fifth and sixth aspects may be applied to any other aspect, wherever appropriate. Likewise, any advantage of the first aspect may equally apply to the second, third, fourth, fifth, and/or sixth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 to 3, 10, 14, and 19 are schematic diagrams illustrating different aspects of two dimensional antenna arrays according to embodiments;

FIG. 4a is a block diagram showing functional units of an antenna arrangement according to an embodiment;

FIG. 4b is a block diagram showing functional modules of an antenna arrangement according to an embodiment;

FIG. 5 schematically illustrates a network node comprising an antenna arrangement according to embodiments;

FIG. 6 schematically illustrates a wireless terminal comprising an antenna arrangement according to embodiments;

FIG. 7 schematically illustrates a computer program product according to an embodiment;

FIGS. 8 and 9 are flowcharts of methods according to embodiments;

FIGS. 11 to 13 schematically illustrate precoder beams in elevation-azimuth plots according to embodiments;

FIGS. 15 and 20 show simulation results according to prior art; and

FIGS. 16 to 18 and 21 to 23 show simulation results according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step illustrated by dashed lines should be regarded as optional.

In general terms, the codebooks specified in the Long Term Evolutions (LTE) telecommunications standards have been designed for being used with one-dimensional (1-D) antenna arrays, typically horizontal linear arrays. Performing two-dimensional (2-D) beam forming (also known as precoding), i.e., beam forming in both the azimuth and elevation domain, using a planar array and the LTE Release 10 codebook may give poor performance if the weight vectors in the codebook are applied directly on the antenna ports. In this respect, joint azimuth/elevation beam forming is commonly referred to as 3-D beam forming.

The embodiments disclosed herein relate to improved beam forming, and in particular to two-dimensional beam forming. In order to obtain such two-dimensional beam forming here is provided a two dimensional antenna array, a method performed by the two dimensional antenna array, a computer program comprising code, for example in the form of a computer program product, that when run on a processing unit, causes the processing unit to perform the method.

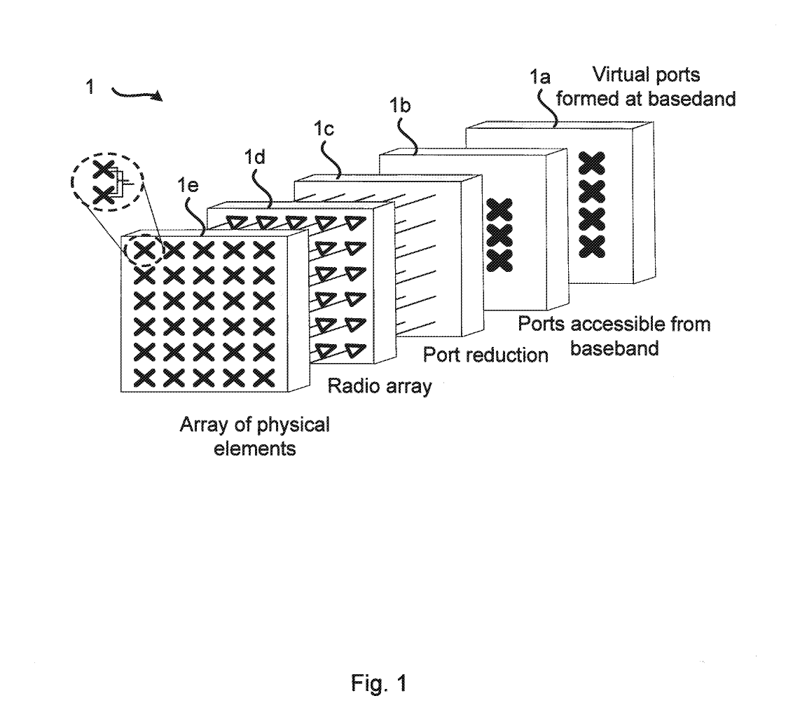

FIG. 1 is a schematic block diagram illustrating an example architecture of a two dimensional antenna array 1 for which embodiments presented herein can be applied. The antenna front end comprises an array 1e of physical antenna elements where each antenna element may be a subarray of several radiating antenna elements connected via a feed network to one physical antenna port (per polarization) for each physical element. Each physical antenna port is connected to a radio chain as comprised in a radio array 1d. The number of antenna ports in block 1b accessible to baseband signal processing may be reduced via a port reduction block is that creates new antenna ports that are (linear) combinations of the input antenna ports. In the baseband signal processing block is virtual antenna ports may be created by matrix multiplications. These virtual antenna ports may be of different type. For example, in LTE they may for a radio base station be common reference signals (CRS) at ports 0-3, channel state information reference signals (CSI-RS) at port 15-22, and UE-specific reference signals at ports 7-14. In some implementations one or several blocks of the in the two dimensional antenna array 1 in FIG. 1 may be removed.

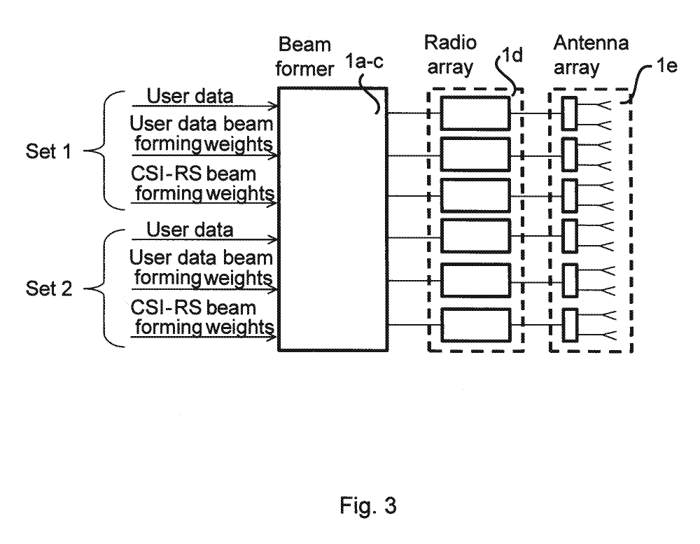

FIG. 3 is a schematic block diagram illustrating a possible implementation of the two dimensional antenna array 1 of FIG. 1. It comprises a beam former comprising blocks 1a, 1b, 1c of FIG. 1, a radio array 1d and a physical antenna array 1e. The beam former 1a-c is configured to receive user data, beam forming weights for the user data, and beam forming weights for reference signals, such as CSI-RS. The beam former 1a-c may be configured to receive one set of user data, beam forming weights for the user data, and beam forming weights for reference signals. However, as will be further disclosed below, the beam former 1a-c is configured to receive at least two sets (in FIG. 3 schematically illustrated by Set 1 and Set 2, respectively) of user data, beam forming weights for the user data, and beam forming weights for reference signals. The same CSI-RS information can be used to form several weights, each one used for transmission of one layer.

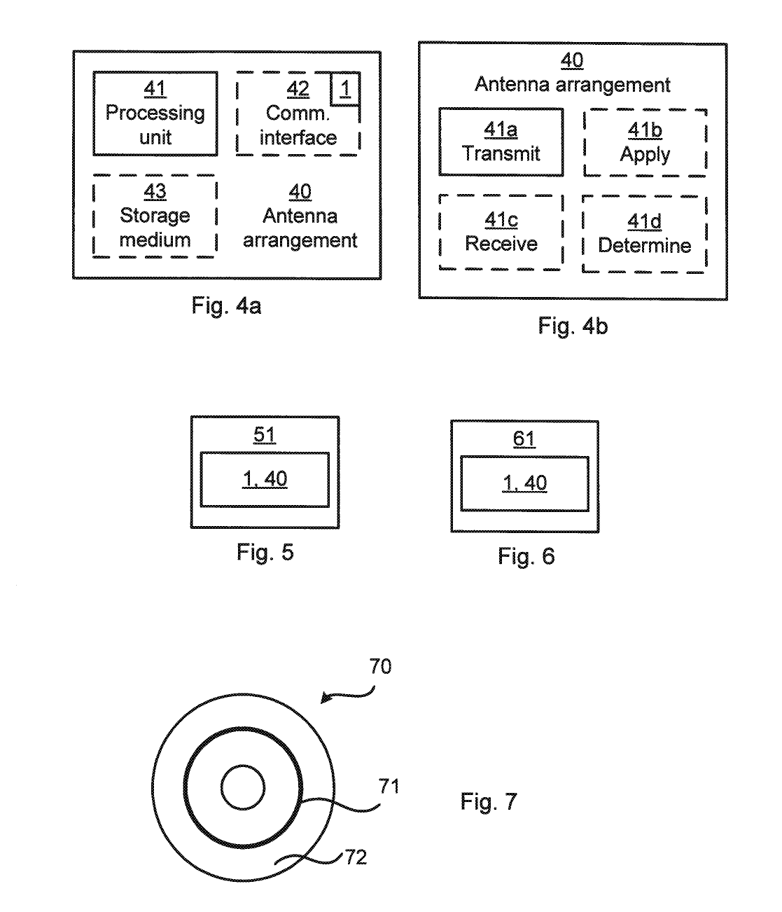

FIG. 4a schematically illustrates, in terms of a number of functional units, the components of an antenna arrangement 40 according to an embodiment. A processing unit 41 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 70 (as in FIG. 7), e.g. in the form of a storage medium 43. If implemented as an ASIC (or an FPGA) the processing unit 41 may by itself implement such instructions. Thus the processing unit 41 is thereby arranged to execute methods as herein disclosed. The storage medium 43 may also comprise persistent storage, which, for example, can be any single one or combination of magnetic memory, optical memory, solid state memory or even remotely mounted memory. The antenna arrangement 40 may further comprise a communications interface 42 for communications with radio transceiver devices, such as network nodes 51 and wireless terminals 61. As such the communications interface 42 may comprise one or more transmitters and receivers, comprising analogue and digital components and a two dimensional antenna array 1 for radio communications. The processing unit 41 controls the general operation of the antenna arrangement 40 e.g. by sending data and control signals to the communications interface 42 and the storage medium 43, by receiving data and reports from the communications interface 42, and by retrieving data and instructions from the storage medium 43. Other components, as well as the related functionality, of the antenna arrangement 40 are omitted in order not to obscure the concepts presented herein.

FIG. 4b schematically illustrates, in terms of a number of functional modules, the components of an antenna arrangement 40 according to an embodiment. The antenna arrangement 4 of FIG. 4b comprises a transmit module 41a. The antenna arrangement 40 of FIG. 4b may further comprises a number of optional functional modules, such as any of a apply module 41b, a receive module 41c, and a determine module 41d. The functionality of each functional module 4a-d will be further disclosed below in the context of which the functional modules 41a-d may be used. In general terms, each functional module 41a-d may be implemented in hardware or in software. The processing unit 41 may thus be arranged to from the storage medium 43 fetch instructions as provided by a functional module 41a-d and to execute these instructions, thereby performing any steps as will be disclosed hereinafter.

The two dimensional antenna array 1 and/or the antenna arrangement 40 may be provided as integrated circuits, as standalone devices or as a part of a further device. For example, the two dimensional antenna array 1 and/or antenna arrangement 40 may be provided in a radio transceiver device, such as in a network node 51 and/or a wireless terminal 61. FIG. 5 illustrates a network node 51 comprising at least one two dimensional antenna array 1 and/or antenna arrangement 40 as herein disclosed. The network node 51 may be a BTS, a NodeB, an eNB, a repeater, a backhaul node, or the like. FIG. 6 illustrates a wireless terminal 61 comprising at least one two dimensional antenna array 1 and/or antenna arrangement 40 as herein disclosed. The wireless terminal 61 may be a user equipment (UE), a mobile phone, a tablet computer, a laptop computer, etc. or the like.

The two dimensional antenna array 1 and/or antenna arrangement 40 may be provided as an integral part of the further device. That is, the components of the two dimensional antenna array 1 and/or antenna arrangement 40 may be integrated with other components of the further device; some components of the further device and the two dimensional antenna array 1 and/or antenna arrangement 40 may be shared. For example, if the further device as such comprises a processing unit, this processing unit may be arranged to perform the actions of the processing unit 41 associated with the antenna arrangement 40. Alternatively the two dimensional antenna array 1 and/or antenna arrangement 40 may be provided as separate units in the further device.

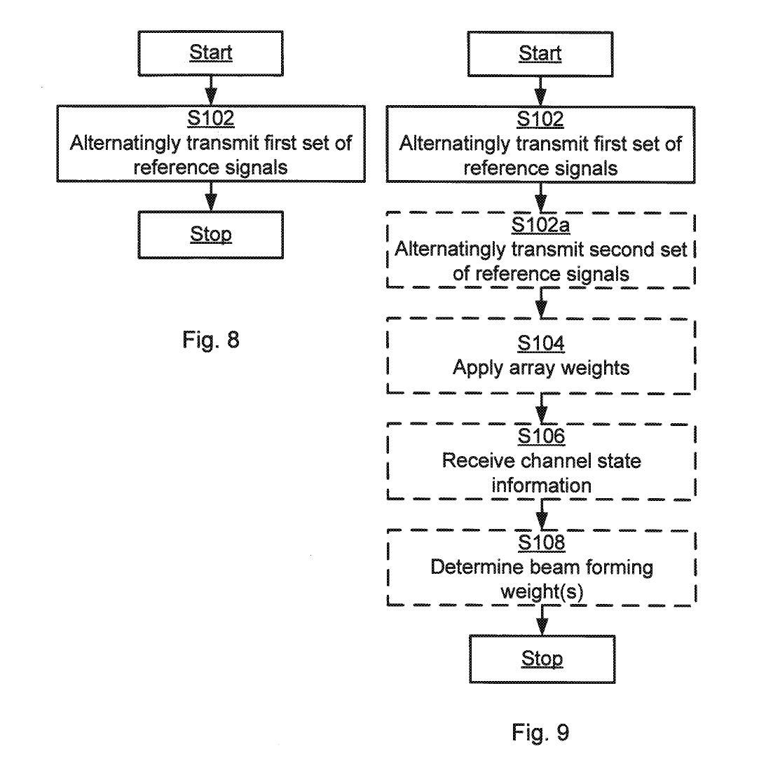

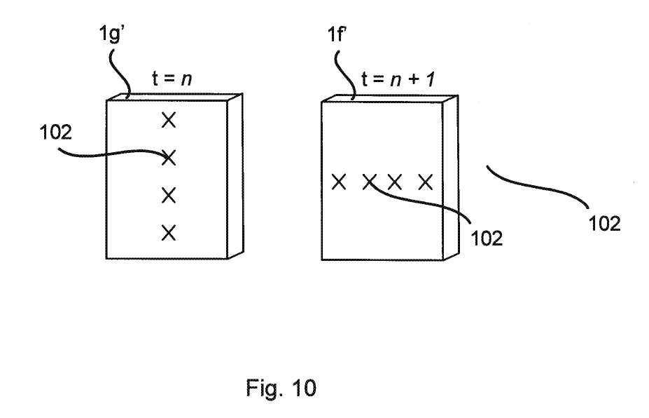

FIGS. 8 and 9 are flow chart illustrating embodiments of methods for two-dimensional beam forming. The methods are performed by the processing. The methods are advantageously provided as computer programs 71. FIG. 7 shows one example of a computer program product 70 comprising computer readable means 72. On this computer readable means 72, a computer program 71 can be stored, which computer program 71 can cause the processing unit 41 and thereto operatively coupled entities and devices, such as the communications interface 42 (and hence the two-dimensional antenna array 1) and the storage medium 43, to execute methods according to embodiments described herein. The computer program 71 and/or computer program product 70 may thus provide means for performing any steps as herein disclosed.

In the example of FIG. 7, the computer program product 70 is illustrated as an optical disc, such as a CD (compact disc) or a DVD (digital versatile disc) or a Blu-Ray disc. The computer program product 70 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 71 is here schematically shown as a track on the depicted optical disk, the computer program 71 can be stored in any way which is suitable for the computer program product 70.

Reference is now made to FIG. 8 illustrating a method for two-dimensional beam forming using a two dimensional antenna array 1 according to an embodiment.

The method comprises in a step S102 alternatingly transmitting a first set of reference signals for acquiring channel state information using a two-dimensional antenna array as a first essentially linear array if and as a second essentially linear array 1g, respectively. The second linear array 1g is substantially perpendicular to the first linear array if. The processing unit 41 may be configured to cause the two-dimensional antenna array 1 to perform step S102. The processing unit may be configured such that it causes the two-dimensional antenna array to, when used as the first linear array, transmit one reference signal of the first set per virtual antenna port in the first linear array. The processing unit may further be configured such that it causes the two-dimensional antenna array to, when used as the second linear array, transmit one reference signal of the first set per virtual antenna port in the second linear array.

The inventive concept thereby makes it possible to utilize the potential of 2-D beam forming with 2-D arrays using the existing LTE standard. The inventive concept may enable beam forming over twice as many antenna ports in each dimension than is made possible according to state of the art since the codebook, according to the inventive concept, is used in one dimension at a time. This gives higher angular resolution in both the channel state information acquisition as well as in the actual beam forming. This also enables the use of a larger antenna which in turn leads to higher gain in the beam forming. The inventive concept may also be useful for codebooks designed for 2-D arrays, since the inventive concept can be used for keeping a low overhead of reference signals.

Embodiments relating to further details of two-dimensional beam forming using a two dimensional antenna array 1 will now be disclosed.

The reference signals may be channel state information reference signals (CSI-RS). As noted above, a network node 51 may comprise a two dimensional antenna arrangement 1 as herein disclosed. The network node 51 may thus be configured to transmit CSI-RS as outlined in step S102.

The reference signals may be sounding reference signals (SRS). As noted above, a wireless terminal 61 may comprise a two dimensional antenna arrangement 1 as herein disclosed. The wireless terminal 61 may thus be configured to transmit SRS as outlined in step S102.

The herein disclosed embodiments are applicable for different types of two-dimensional antenna arrays. For example, according to an embodiment the two-dimensional antenna array is an N1-by-N2 two-dimensional antenna array, where N1>1 and N2>1 are integers. However, according to other embodiments the two-dimensional antenna array may have another shape, for example being a circular two-dimensional antenna array.

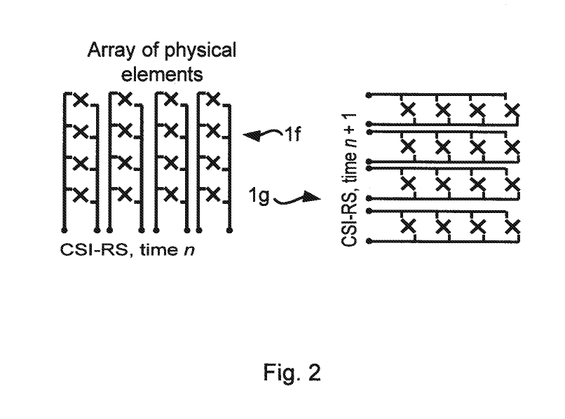

There may be different ways to provide the first linear array and the second linear array. For example, according to an embodiment the first linear array is a linear horizontal array, and the second linear array is a linear vertical array. Hence the first linear array and the second linear array may together form a “+”-shape. However, according to other embodiments the first linear array and the second linear array are rotated in view of the vertical and the horizontal axis. Hence the first linear array and the second linear array may together form a “x”-shape. An illustration of a general embodiment of the first linear array and the second linear array is illustrated in FIG. 10; in the left part of FIG. 10 the two-dimensional antenna array 1 is used as a vertical array 1g′ and in the right part of FIG. 10 the two-dimensional antenna array 1 is used as a horizontal array if. FIG. 10 schematically illustrates phase center positions, one of which is identified at reference numeral 102, of the virtual ports at two consecutive time instants. As the skilled person understands, a similar illustration as that of FIG. 10 could be used for different frequency subbands, code resources, or two different sets of reference signals. The virtual antenna ports may be created by the architecture in FIG. 2.

Assume, for example, that eight CSI-RS ports can be formed by combining sufficiently many radiating elements so that all CSI-RS ports have the same power pattern, but can have different polarizations. According to state of the art the CSI-RS ports are arranged in a rectangular lattice (left part of FIG. 10) and the CSI-RSs are transmitted on all these antenna ports in each time instant. According to beam forming as herein disclosed, the CSI-RS ports may instead be arranged sequentially in time as a horizontal and vertical linear array, respectively (right part of FIG. 10).

Thus, according to some embodiments presented herein channel state information reference signals (CSI-RS) may be alternatingly transmitted on the rows and columns of a planar antenna array. In this way, channel state information (CSI) about both the elevation and azimuth domain can be obtained by combining channel state reports of two CSI-RS transmissions, see below. As will also be further disclosed below, this CSI may then be used to design 2-D beam forming weights for the full planar antenna array.

There may be different ways to alternatingly transmitting the reference signals, as in step S102. For example, the reference signals may be alternatingly transmitted in the time domain, in the frequency domain, and in the code domain.

In this respect, multiple CSI-RS processes in LTE are not transmitted completely simultaneously in completely the same frequency. Some CSI-RS signals are transmitted in different physical resource elements, i.e., using different subcarriers and orthogonal frequency-division multiplexing (OFDM) symbols. However, the multiple CSI-RS processes are transmitted in the same physical resource block (consisting of 12 subcarriers and 7 OFDM symbols) so at this level of granularity in the time-frequency grid they are regarded as transmitted simultaneously in the same frequency band. Thus, when transmitting simultaneously at the same frequency in LTE is meant in the same physical resource blocks.

According to one embodiment the reference signals are alternatingly transmitted over time (and in the same frequency band). For example, one reference signal per virtual antenna port in the first linear array may be transmitted in a first time slot, and one reference signal per virtual antenna port in the second linear array may be transmitted (in the same frequency band) in a second time slot. After having transmitted reference signals in the second time slot, reference signals may again be transmitted as in the first time slot, and so on. For example, one reference signal per virtual antenna port in the first linear array may be transmitted at time slot n (or every 2n:th time slot) and one reference signal per virtual antenna port in the second linear array may be transmitted at time slot n+1 (or every 2n+1:th), where n is an integer.

According to one embodiment the reference signals are alternatingly transmitted over frequency (and simultaneously over time). For example, one reference signal per virtual antenna port in the first linear array may be transmitted in a first frequency subband, and one reference signal per virtual antenna port in the second linear array may be transmitted (simultaneously over time) in a second frequency subband.

According to one embodiment the reference signals are alternatingly transmitted using different code resources (and simultaneously over time and/or in the same frequency band). The code resources may be based on binary block codes. For example, one reference signal per virtual antenna port in the first linear array may be transmitted using a first code resource, and one reference signal per virtual antenna port in the second linear array may be transmitted (simultaneously over time and/or in the same frequency band) using a second code resource. The first code resource and the second code resource may be orthogonal in relation to each other.

As an illustrative example, consider a square antenna array with 4-by-4 dual-polarized radiating elements as illustrated in FIG. 2 (where each “X” represents a dual-polarized antenna element). It is for simplicity and without loss of generality assumed that all antenna elements are equipped with their own radio branch and digital to analog converter (DAC) so that all array reconfigurations can be made by digital signal processing. In a first time instant (or in a first frequency subband or using a first code resource, see above) the antenna array is used as a first linear (horizontal) array. According to the illustrative example, one CSI-RS per column and polarization is transmitted, as illustrated in the left part of FIG. 2. In the next time instant (or in a second frequency subband or using a second code resource, see above) the antenna array is used as a second linear (vertical) array According to the illustrative example one CSI-RS per row and polarization is transmitted, as illustrated in the right part of FIG. 2.

Reference is now made to FIG. 9 illustrating methods for two-dimensional beam forming using a two dimensional antenna array 1 according to further embodiments.

According to some embodiments, weights are applied to the antenna elements. Hence, according to an embodiment the processing unit 41 of the antenna arrangement 40 is arranged to, in an optional step S104, apply array weights to antenna elements of the two-dimensional antenna array during alternatingly transmitting the reference signals. For example, array weights may be applied over vertically stacked antenna elements in order to get a desired elevation beam shape when the antenna array is used as linear horizontal array. For example, array weights may be applied over horizontally arranged antenna elements in order to get a desired azimuth beam shape when the antenna array is used as linear vertical array.

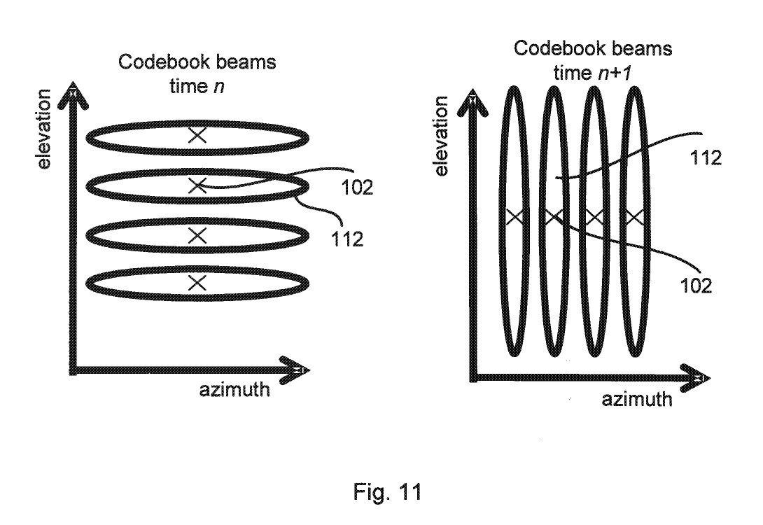

FIG. 11 schematically illustrates rank-one precoder beams for different precoding matrix indicators (PMIs) corresponding to the two configurations illustrated in an azimuth/elevation plane. More particularly, FIG. 11 schematically illustrates codebook beams, on of which is identified at reference numeral 112, and phase center positions (by means of “X”, 102) of CSI-RS antenna ports when the planar antenna array is used alternatingly as a horizontal and vertical linear antenna array, respectively. At time n (or in a first frequency subband or using a first code resource, see above), when the antenna array is used as a first (horizontal) linear array, the codebook beams will provide information about the azimuth directions to the UEs. A time n+1 (or in a second frequency subband or using a second code resource, see above), when the antenna array is used as a second (vertical) linear array, the codebook beams will provide information about the elevation directions to a radio transceiver device receiving the reference signals transmitted in S102.

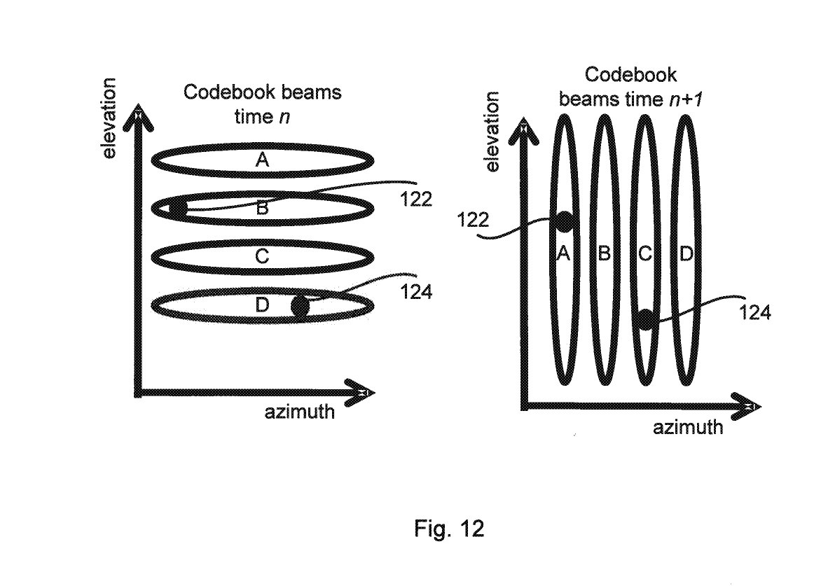

Assume that there are two radio transceiver devices 61 present whose azimuth and elevation directions are illustrated by black dots 122, 124 in each plot of FIG. 12. Ideally, the left radio transceiver device receiving the reference signals transmitted in S102 (represented by the left black dot 122 in each plot) would choose precoder beam B at time n (or in a first frequency subband or using a first code resource, see above) and precoder beam A at time n+1 (or in a second frequency subband or using a second code resource, see above). Correspondingly, the right radio transceiver device receiving the reference signals transmitted in S102 (represented by the right black dot 124 in each plot) would choose precoder beam D at time n (or in a first frequency subband or using a first code resource, see above) and precoder beam C at time n+1 (or in a second frequency subband or using a second code resource, see above).

Based on, for example, PMI reports from the radio transceiver device receiving the reference signals transmitted in S102, 2-D beam forming may be performed using the whole antenna array.

Reference is now made to FIG. 9 illustrating methods for two-dimensional beam forming using a two dimensional antenna array 1 according to further embodiments.

The 2-D beam forming of the actual user data is then performed by combining received channel state information. The method may therefore comprise an optional step S106 of receiving channel state information from a radio transceiver device receiving the reference signals transmitted in S102 by the first linear array and the second linear array, respectively, for example so as to obtain elevation domain information and azimuth domain information from the radio transceiver device receiving the reference signals transmitted in S102 (assuming that the first linear array is a vertical array and that the second linear array is a horizontal array).

The received channel state information may be used to determine beam forming weights. The method may therefore comprise an optional step S108 of determining at least one two-dimensional beam forming weight for the radio transceiver device based on said elevation domain information and said azimuth domain information.

Two (dependent or independent) 1-D weights may form one 2-D weight. For example, the at least one two-dimensional beam forming weight may be determined as a combination of a horizontal beam forming weight and a vertical beam forming weight. The horizontal beam forming weight may be based on the azimuth domain information, and the vertical beam forming weight may be based on the elevation domain information.

For example, with a rectangular antenna array (lattice) and assuming separable weights the 2-D beam forming weights may be given by

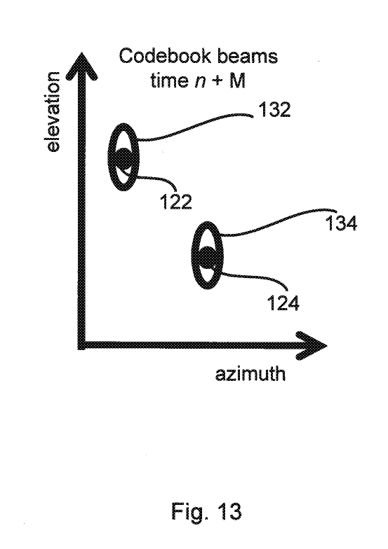

wₘₙ=wₘwₙ,

where wₘₙ are the 2-D weights and wₘ and wₙ are the 1-D weights. As the skilled person understands, if desired, more sophisticated pattern synthesis can be used to determine the 2-D weights since there is no requirement on using the codebook weights for the user data transmission. The resulting 2-D beam patterns 132, 133 used for the data transmission to the two radio transceiver devices 61 of FIG. 12 are illustrated in FIG. 13.

As noted above, the beam former 1a-c of FIG. 3 may be configured to receive at least two sets of user data, beam forming weights for the user data, and beam forming weights for reference signals. Further details relating thereto will now be disclosed. According to embodiments multiple sets of reference signals, corresponding to multiple CSI-RS processes, may simultaneously be transmitted from one two dimensional antenna array. The multiple sets of reference signals may be used for increasing the number of antenna ports that are used for CSI estimation. This may improve the angular resolution (and/or yielding dense channel estimations) in the CSI estimation and thereby make it useful to use a correspondingly increased number of antenna ports for the beam forming of the user data, which in turn may improve the beam forming gain.

Therefore, according to an embodiment the method further comprises an optional step S102a of alternatingly transmitting also a second set of reference signals for channel state information using the two-dimensional antenna array 1 as the first essentially linear array if and as the second essentially linear array 1g, respectively. According to this embodiment, when transmitting one reference signal of the first set of reference signals using the first linear array, one reference signal of the second set of reference signals is simultaneously transmitted using the second linear array. Also according to this embodiment, when transmitting one reference signal of said first set of reference signals using the second linear array one reference signal of the second set of reference signals using the first linear array is simultaneously transmitted.

This may alleviate the need for several CSI-RS transmissions of a single process over multiple time slots (or frequency subbands or code resources, see above), therefore relaxing any requirements on the channel being stationary during alternatingly transmitting the reference signals. Another possible advantage with this approach exists if the radio transceiver device receiving the reference signals transmitted in S102 reports CSI based on an average of several CSI-RS transmissions over time or frequency. Then the CSI based on vertical/horizontal subarrays or different angular sectors may be mixed up. By using simultaneous transmission of multiple CSI-RS processes there may be no such problem.

In summary, according to some embodiments disclosed herein, 2-D beam forming using a planar array and the LTE release 10 codebook is performed by first using the codebook for sequentially gathering CSI in the azimuth and elevation domain with an array partitioning that is well suited for the codebook and then use this CSI to compute weights for joint 2-D beam forming. These 2-D weights are not part of the standardized codebook. This approach is inter alia enabled by the introduction of precoded demodulation reference signals (DM-RS) in the LTE standard since it decouples the precoding weights used for the transmission of user data from the precoding weights used in the feedback of CSI.

Results of the herein disclosed beam forming will now be compared to beam forming according to state of the art. In general terms, the increased antenna gain that can be achieved using the herein disclosed beam forming depends on what it is being compared with. Here, two different comparisons are made; one when the antenna area is changed and one where the antenna area is constant (compared to state of the art). In both cases it is assumed that the angular coverage of the antenna ports transmitting the reference signals is the same. This means that the antenna power pattern should be the same for all antenna ports transmitting the reference signals. It is also assumed that all radiating antenna elements have the same radiation pattern.

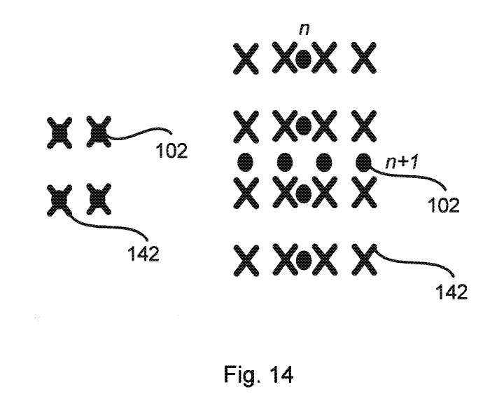

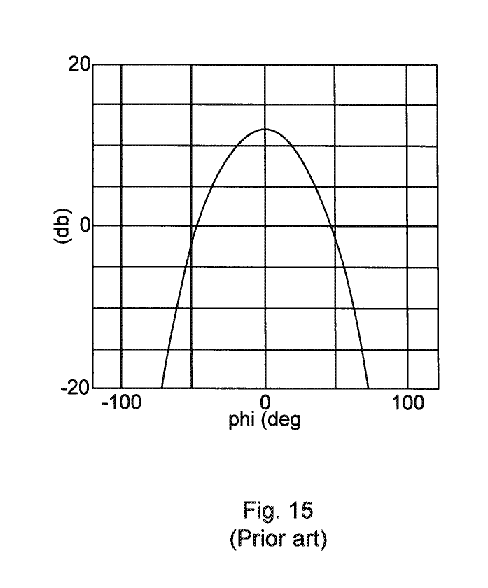

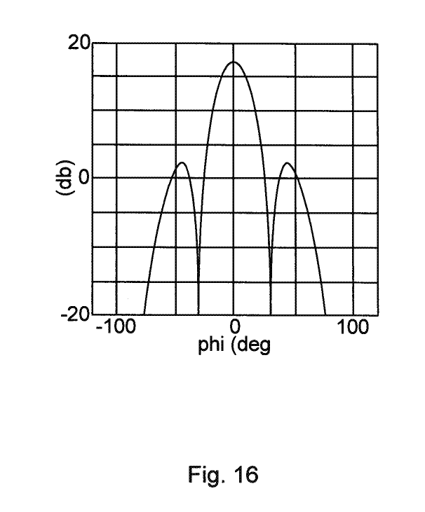

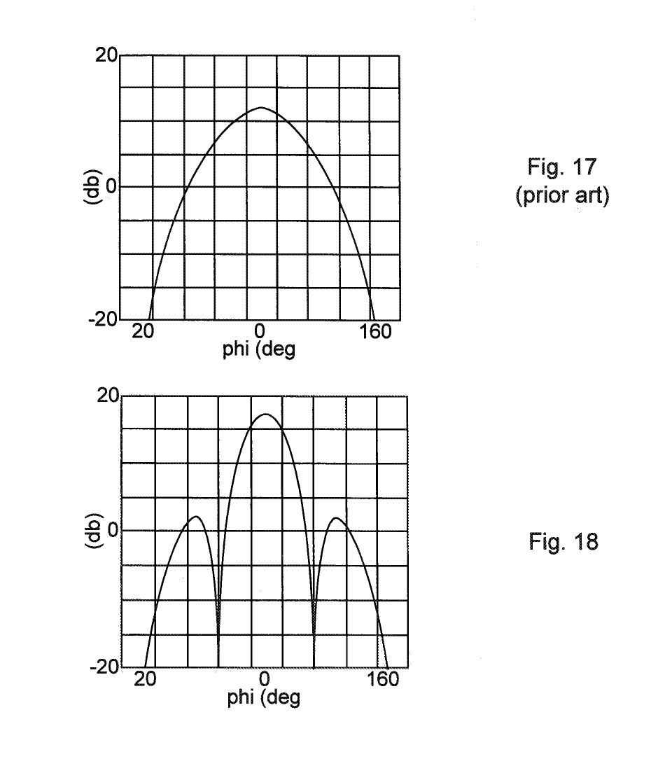

One way to make the comparison is to compare a 2-by-2 antenna array with a 4-by-4 antenna array; see FIG. 14 where a state of the art configuration for beam forming is schematically illustrated to the left and where configuration for beam forming according to herein disclosed embodiments is schematically illustrated to the right. This comparison can be motivated by that the herein disclosed two-dimensional beam forming using a two dimensional antenna array 1 makes it possible to apply the LTE Release 10 codebook on a larger array than what is possible according to state of the art. In FIG. 14 the crosses, one of which is identified at reference numeral 142, represent the positions of the dual-polarized radiating elements and the dots, one of which is identified at reference numeral 102, represent the phase center positions of the CSI-RS antenna ports (each dot represents two CSI-RS antenna ports since dual-polarized elements have been assumed). For to the herein disclosed two-dimensional beam forming (as represented by the configuration to the right) it has been assumed that the CSI-RS antenna ports have been formed by dual-polarized beam forming of all rows and columns, respectively, at two different time instants. With this approach all power amplifiers (Pas) of the antenna arrangement 40 can be fully utilized whilst having the same power pattern for the CSI-RS antenna ports as an individual radiating element. Thus the coverage of the CSI-RS antenna ports are the same for the beam forming according to state of the art and the herein disclosed beam forming. As the skilled person understands, other possibilities to form the CSI-RS antenna ports are also possible within the herein disclosed embodiments. In the actual beam forming, twice as many antenna ports in each dimension can be used according to the beam forming of the herein disclosed embodiments since the codebook can been used in one dimension at a time. Azimuth and elevation cuts of directivity-normalized beam forming radiation patterns for these two array configurations are shown in FIGS. 15, 16, 17, and 18, assuming 80° half-power beam width for the individual radiating elements. In this case the herein disclosed beam forming has 5.4 dB (decibel) higher antenna gain than beam forming according to state of the art. The beam forming according to the state of the art here refers only to the actual antenna configuration being used, assuming that true 2-D beam steering can be used. Taking into account that true 2-D beam steering cannot be performed according to state of the art beam forming (assuming that the LTE Release to codebook is applied directly on the physical antenna ports of a rectangular array), the gain with the herein disclosed beam forming will be even higher. The herein disclosed beam forming also has lower sidelobes than state of the art beam forming.

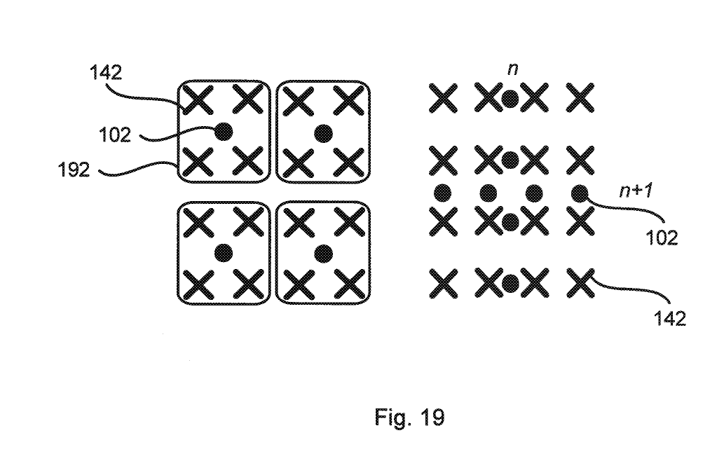

However, this comparison may seem unfair since antenna arrays with different antenna areas are being compared, which obviously will lead to a difference in antenna gain. Another way to make the comparison is thus to compare antenna arrays with the same antenna area. The antenna according to state of the art in this case is an antenna array with 4-by-4 radiating elements combined into 2-by-2 subarrays, one of which is identified at reference numeral 192, where each subarray consists of 2-by-2 radiating elements, see FIG. 19; where a state of the art configuration for beam forming is schematically illustrated to the left and where configuration for beam forming according to herein disclosed embodiments is schematically illustrated to the right. In FIG. 19 the crosses, one of which is identified at reference numeral 142, represent the positions of the dual-polarized radiating elements and the dots, one of which is identified at reference numeral 102, represent the phase center positions of the CSI-RS antenna ports (each dot represents two CSI-RS antenna ports since dual-polarized elements have been assumed).

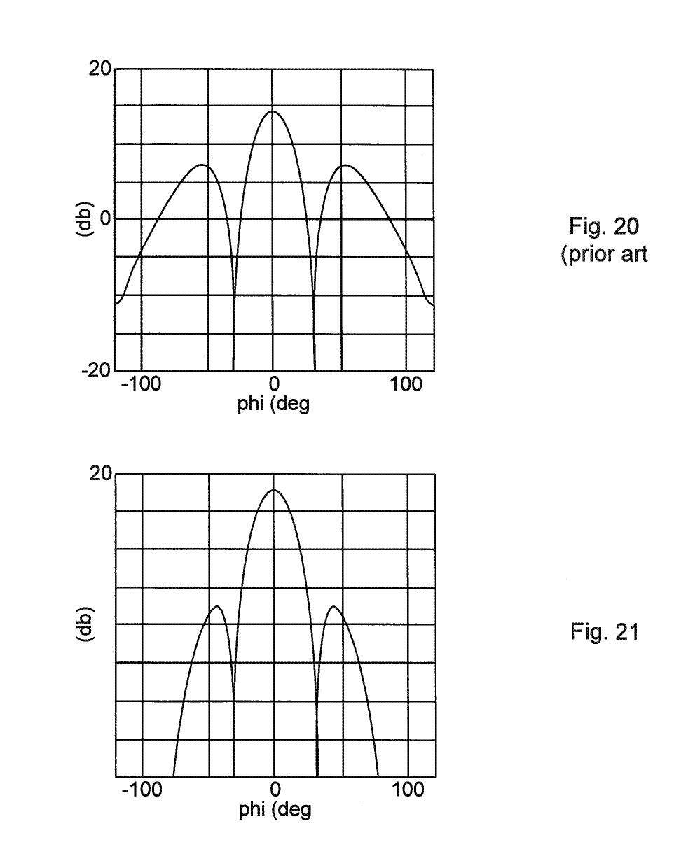

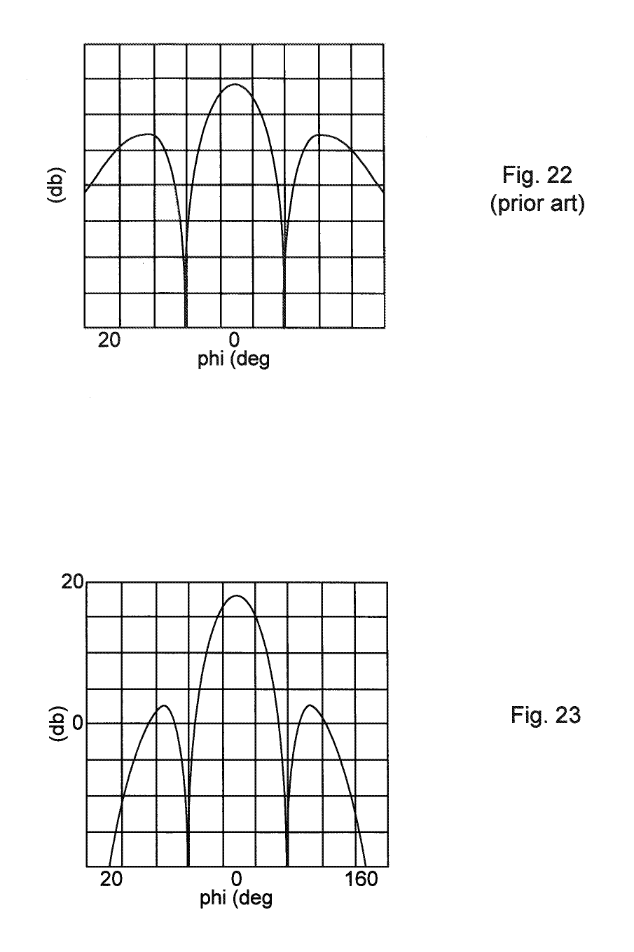

In order for the two array configurations of FIG. 19 to have the same angular coverage for the CSI-RS antenna ports, the subarrays in the left configuration should have the same power pattern as one radiating element. This can be achieved by forming four subarrays with dual-polarized beam forming. Azimuth and elevation cuts of directivity-normalized beam forming radiation patterns for these two array configurations are shown in FIGS. 20, 21, 22, and 23, assuming 80° half-power beam width for the individual radiating elements. In this case the herein disclosed beam forming has about 3 dB higher antenna gain than beam forming according to state of the art. The herein disclosed beam forming also has lower sidelobes than the beam forming according to state of the art. The increase in antenna gain (although the antenna area is the same) is due to that the subarrays in beam forming according to state of the art do not have higher gain than one individual radiating element. This is required for the beam forming according to state of the art and the herein disclosed beam forming to have the same angular coverage of the CSI-RS ports.

The plots in FIGS. 20-22 are shown for a case when the beam is steered to 0°. This is the most favorable case for the beam forming according to state of the art. Since the phase center distance between the CSI-RS ports in the state of the art antenna array in FIG. 19 is twice that of the herein disclosed beam forming, grating lobes will appear when the beam is steered away from boresight. This will decrease the gain since energy is wasted in grating lobes (also causing increased interference). Therefore, for other beam steering angles than 0° the herein disclosed beam forming will have more than 3 dB higher antenna gain, e.g., 5 dB for 30° beam steering in both azimuth and elevation.

The 3 dB and 6 dB increase in antenna gain is the increase in maximum antenna gain, assuming that the beam can actually be steered in the desired direction. It may not be possible to perform true 2-D beam steering using the LTE Release 10 codebook on a rectangular array if the weight vectors are applied directly on the antenna ports. Therefore, the effective increase in antenna gain will be larger than 3 dB and 6 dB with the herein disclosed beam forming since this can perform true 2-D beam steering.

The inventive concept has mainly been described above with reference to a few embodiments. However, as is readily appreciated by a person skilled in the art, other embodiments than the ones disclosed above are equally possible within the scope of the inventive concept, as defined by the appended patent claims. For examples, although relating to CIE releases 10 and 11, the herein disclosed embodiments may also be applicable to earlier LTE releases by using a similar transmission scheme for the cell-specific reference signals and, e.g., transmission mode 7. For examples, although using LTE specific terminology, the herein disclosed embodiments may also be applicable to communications networks not based on LTE, mutatis mutandis.

1. A method for two-dimensional beam forming using a two dimensional antenna array, comprising the step of:
alternatingly transmitting a first set of reference signals for acquiring channel state information using a two-dimensional antenna array as a first essentially linear array and as a second essentially linear array substantially perpendicular to the first linear array, respectively; wherein
when used as said first linear array one reference signal of said first set per virtual antenna port in said first linear array is transmitted; and
when used as said second linear array one reference signal of said first set per virtual antenna port in said second linear array is transmitted.

2. The method according to claim 1, further comprising:
applying array weights to antenna elements of the two-dimensional antenna array during said alternatingly transmitting of the reference signals.

3. The method according to claim 1, further comprising:
receiving channel state information from a radio transceiver device having received the reference signal transmitted by the first linear array and the second linear array, respectively, so as to obtain elevation domain information and azimuth domain information from the radio transceiver device.

4. The method according to claim 3, further comprising:
determining at least one two-dimensional beam forming weight for the radio transceiver device based on said elevation domain information and said azimuth domain information.

5. The method according to claim 4, wherein the at least one two-dimensional beam forming weight is determined as a combination of a horizontal beam forming weight and a vertical beam forming weight, and wherein the horizontal beam forming weight is based on the azimuth domain information, and wherein the vertical beam forming weight is based on the elevation domain information.

6. The method according to claim 1, wherein the reference signals are alternatingly transmitted over time.

7. The method according to claim 1, wherein the reference signals are alternatingly transmitted over frequency, wherein said one reference signal per virtual antenna port in said first linear array is transmitted in a first frequency subband, and wherein said one reference signal per virtual antenna port in said second linear array is transmitted in a second frequency subband.

8. The method according to claim 1, wherein the reference signals are alternatingly transmitted using different code resources.

9. The method according to claim 1, wherein the two-dimensional antenna array is an N1-by-N2 two-dimensional antenna array, where N1>1 and N2>1.

10. The method according to claim 1, wherein said first linear array is a linear horizontal array, and wherein said second linear array is a linear vertical array.

11. The method according to claim 1, wherein the reference signals are channel state information reference signals, CSI-RS.

12. The method according to claim 1, wherein the reference signals are sounding reference signals, SRS.

13. The method according to claim 1, further comprising:
alternatingly transmitting also a second set of reference signals for channel state information using said two-dimensional antenna array as said first essentially linear array and as said second essentially linear array, respectively; wherein
when transmitting one reference signal of said first set of reference signals using said first linear array, simultaneously transmitting one reference signal of said second set of reference signals using said second linear array; and
when transmitting one reference signal of said first set of reference signals using said second linear array, simultaneously transmitting one reference signal of said second set of reference signals using said first linear array.

14. A two dimensional antenna arrangement for two-dimensional beam forming, comprising a processing unit configured to cause a two-dimensional antenna array to:
alternatingly transmit a first set of reference signals for acquiring channel state information using the two-dimensional antenna array as a first essentially linear array and as a second essentially linear array substantially perpendicular to the first linear array, respectively;
wherein the processing unit is configured such that it causes the two-dimensional antenna array to, when used as said first linear array, transmit one reference signal of said first set per virtual antenna port in said first linear array; and
wherein the processing unit is configured such that it causes the two-dimensional antenna array to, when used as said second linear array, transmit one reference signal of said first set per virtual antenna port in said second linear array.

15. The two dimensional antenna arrangement according to claim 14, further comprising:
applying array weights to antenna elements of the two-dimensional antenna array during said alternatingly transmitting of the reference signals.

16. The two dimensional antenna arrangement according to claim 14, wherein the processing unit further is configured to:
receive channel state information from a radio transceiver device having received the reference signal transmitted by the first linear array and the second linear array, respectively, so as to obtain elevation domain information and azimuth domain information from the radio transceiver device.

17. The two dimensional antenna arrangement according to claim 16, wherein the processing unit further is configured to:
determine at least one two-dimensional beam forming weight for the radio transceiver device based on said elevation domain information and said azimuth domain information.

18. The two dimensional antenna arrangement according to claim 14, wherein the processing unit further is configured to cause the two-dimensional antenna array to:
alternatingly transmit also a second set of reference signals for channel state information using said two-dimensional antenna array as said first essentially linear array and as said second essentially linear array, respectively; wherein
when transmitting one reference signal of said first set of reference signals using said first linear array, simultaneously transmitting one reference signal of said second set of reference signals using said second linear array; and
when transmitting one reference signal of said first set of reference signals using said second linear array, simultaneously transmitting one reference signal of said second set of reference signals using said first linear array.

19. A network node comprising a two dimensional antenna arrangement according to claim 14.

20. A wireless terminal comprising a two dimensional antenna arrangement according to claim 14.

21. A computer program for two-dimensional beam forming, the computer program comprising computer program code which, when run on a processing unit, causes the processing unit to:
alternatingly transmit a first set of reference signals for acquiring channel state information using a two-dimensional antenna array as a first essentially linear array and as a second essentially linear array substantially perpendicular to the first linear array, respectively;
wherein the computer program is configured such that it causes the two-dimensional antenna array to, when used as said first linear array, transmit one reference signal of said first set per virtual antenna port in said first linear array; and
wherein the computer program is configured such that it causes the two-dimensional antenna array to, when used as said second linear array, transmit one reference signal of said first set per virtual antenna port in said second linear array.

22. A computer program product comprising a computer program according to claim 21, and a computer readable means on which the computer program is stored.
